(19) United States
(12) Patent Application Publication
(10) Pub. No.: US 2025/0165684 A1
(43) Pub. Date: May 22, 2025

(54) Method, system, device and storage medium for predicting initiation of rock fractures

(71) Applicant: Chongqing University, Chongqing (CN)

(72) Inventors: Saipeng Huang, Chongqing (CN); Xinyu Zhang, Chongqing (CN); Lulu Xu, Chongqing (CN)

(73) Assignee: Chongqing University, Chongqing (CN)

(21) Appl. No.: 19/025,078

(22) Filed: Jan. 16, 2025

(30) Foreign Application Priority Data
Apr. 7, 2024 (CN) CN202410413372.0

(51) Int. Cl. G06F 30/28

(52) U.S. Cl. CPC G06F 30/28

(57) ABSTRACT

The present disclosure provides a method, system, device and storage medium for predicting the initiation of rock fractures. The method comprises: obtaining rock fracture data in the reservoir, establishing a double fracture model, applying confining pressures of different strata to the boundary of the double fracture model to change stress differences of horizontal confining pressures and obtain different horizontal stress differences, analyzing the corresponding stress changes of maximum principal stresses and maximum shear stresses on both sides of a fracture and a fracture tip as the horizontal stress differences change, and obtaining a stress state at the fracture tip and both sides of the fracture, predicting whether the fracture is initiating. The method can quickly clarify the fracture initiation law and characteristic, analyze the stress state at the fracture tip and both sides of the fracture, and thus improve the accuracy of fracture initiation prediction.

### CROSS-REFERENCE TO RELATED APPLICATION

This application claims priority to Chinese Patent Application No. 202410413372.0, filed on Apr. 7, 2024 before the China National Intellectual Property Administration, the disclosure of which is incorporated herein by reference in entirety.

### TECHNICAL FIELD

The present disclosure relates to the field of rock fracture prediction technology, and in particular to a method, system, device and storage medium for predicting the initiation of rock fractures.

### BACKGROUND

Hydraulic fracturing is to use a ground high-pressure pump to squeeze a fracturing fluid with a high viscosity into the oil layer through a wellbore. When the injection speed of the fracturing fluid exceeds the absorption capacity of the oil layer, a very high pressure is formed on the oil layer at the bottom of the well. When this pressure exceeds the fracture pressure of the oil layer rock near the bottom of the well, the oil layer will be pressed open and cracks will be generated. One of the main research contents of hydraulic fracturing is the study of the mechanism and characteristic of fracture initiation, expansion, evolution, and the most effective technology is used to accurately monitor the spatial expansion morphology of hydraulic fractures.

Current research work mainly focuses on the influence of the rock mechanical properties of the reservoir and the complex natural fracture system on the initiation and expansion of fractures. Although horizontal stress and vertical stress have been used in two-dimensional form to study the direction of cracks, there are few studies that show horizontal principal stress and vertical stress in three-dimensional form, which is also the real form of ground stress in real reservoirs. In this case, the initiation mechanism of natural fractures has not been fully studied and explained in the state of three-dimensional stress field.

The initiation and expansion of fractures in deep reservoirs are often difficult to be accurately predicted by effective means. For example, for the initiation and expansion of hydraulic fracturing fractures on site, the microseismic waves generated by rock fractures caused by hydraulic fracturing are monitored, the three-component data of microseismic is used, and then the imaging distribution characteristics of fractures in the fracturing area are obtained by using accurate interpretation. Although microseismic means can restore the distribution characteristics of underground fracture expansion through real-time monitoring and interpretation of microseismic waves in deep formations, it is difficult to accurately capture the initiation behavior of fractures. At present, rock initiation is often completed through laboratory testing. For example, acoustic emission technology is widely used in monitoring the acoustic emission signals generated by rock damage during the experiment, and the rock fracture characteristics are restored by interpreting and processing the signals. However, although the above technologies can accurately capture the initiation point of rock fractures, it is difficult to determine the initiation type. In addition, due to the limitations of experimental conditions, indoor experimental tests cannot fully simulate the real geostress environment, resulting in inaccurate prediction of the initiation of cracks in the target formation, and inevitable deviations in the final experimental results.

### SUMMARY

In view of the shortcomings of the prior art that the actual geostress environment cannot be fully simulated, resulting in inaccurate prediction of the initiation of cracks in the target formation, the present disclosure proposes a method, system, device and storage medium for predicting initiation of rock fractures, which simulates the initiation mechanism of cracks based on finite element analysis, helps to predict and verify the initiation mode and type of hydraulic fractures generated by hydraulic fracturing, thereby solving the problems existing in the prior art.

A method for predicting initiation of rock fractures, comprising the following steps:
obtaining rock fracture data in a reservoir of a working area;
adopting a finite element software ANSYS to establish a double fracture model based on the fracture data;
applying confining pressures of different strata to a boundary of the double fracture model to change stress differences of horizontal confining pressures and obtain different horizontal stress differences;
according to the different horizontal stress differences, analyzing the corresponding stress changes of maximum principal stresses and maximum shear stresses on both sides of a fracture and a fracture tip as the horizontal stress differences change, and obtaining a stress state at the fracture tip and both sides of the fracture;
predicting whether the fracture is initiating by the stress state at the fracture tip and both sides of the fracture, wherein when the highest value of the maximum shear stresses at the fracture tip and both sides of the fracture is greater than a shear modulus of the reservoir, or the highest value of the maximum principal stresses at the fracture tip and both sides of the fracture is greater than a compressive strength of the reservoir, it is judged that the fracture is initiating.

According to some embodiments of the present disclosure, the establishment of the double fracture model specifically comprises the following steps:
acquiring lengths, widths, densities and distribution orientations of the fractures in the reservoir;
using the finite element software ANSYS to establish a slab model, and implanting two fractures in the slab model, wherein the two fractures are parallel to each other and are distributed at a 45° inclination, the length and width of the two fractures are 0.5 m and 0.02 m respectively, and a perpendicular distance between two fracture tips is 0.5 m;
by meshing the slab model and fracture peripheries and fracture tips, establishing the double fracture model.

According to some embodiments of the present disclosure, the maximum principal stress comprises tensile stress and compressive stress, wherein when the fracture initiation occurs at a position with the maximum tensile stress, a tensile fracture is formed; when the fracture initiation occurs at a position with the maximum compressive stress, a compressive fracture is formed; when the tensile stress exceeds a tensile strength that the rock fracture itself can withstand, the tensile fracture is first cracked; when the compressive stress exceeds a compressive strength that the rock itself can withstand, the compressive fracture is first cracked.

According to some embodiments of the present disclosure, the step of “according to the different horizontal stress differences, analyzing the corresponding stress changes of maximum principal stresses and maximum shear stresses on both sides of a fracture and a fracture tip as the horizontal stress differences change, and obtaining a stress state at the fracture tip and both sides of the fracture” specifically comprises:
when the horizontal stress difference is close to 0 MPa, the maximum principal stress on both sides of the fracture is evenly distributed; and as the horizontal stress difference increases, the maximum principal stress on the same fracture edge is unevenly stressed, and the fracture surface bends or breaks under the action of stress and strain; wherein two stress distribution states occur on the fracture surface: as the horizontal stress difference increases, the maximum principal stress decreases; or as the horizontal stress difference increases, the maximum principal stress increases accordingly;
as the horizontal stress difference increases, the maximum shear stress increases, and the fracture initiates in the middle of the fracture tip to form a shear fracture.

According to some embodiments of the present disclosure, the stress changes of the maximum principal stresses on both sides of the fracture and the maximum shear stress at the fracture tip with the change of the horizontal stress differences are analyzed by establishing a plane change cloud map of the maximum principal stresses on both sides of the fracture and the maximum shear stress at the fracture tip with the change of the horizontal stress differences according to different horizontal stress differences.

According to another aspect of the present disclosure, there is provided a system for predicting initiation of rock fractures, comprising:
an acquisition module for acquiring rock fracture data in a reservoir of a working area;
a model establishing module for establishing a double fracture model based on the fracture data by adopting a finite element software ANSYS;
a confining pressure application module for applying confining pressures of different strata to a boundary of the double fracture model to change stress differences of horizontal confining pressures and obtain different horizontal stress differences;
an analysis module for analyzing the corresponding stress changes of the maximum principal stresses and the maximum shear stresses at both sides of a fracture and a fracture tip as the horizontal stress differences change, and obtaining a stress state at the fracture tip and both sides of the fracture, according to the different horizontal stress differences;
a prediction module for predicting whether the fracture is initiating by the stress state at the fracture tip and both sides of the fracture, wherein when the highest value of the maximum shear stresses at the fracture tip and both sides of the fracture is greater than a shear modulus of the reservoir, or the highest value of the maximum principal stresses at the fracture tip and both sides of the fracture is greater than a compressive strength of the reservoir, the fracture is judged to be initiating.

According to another aspect of the present disclosure, there is provided a computer device for predicting initiation of rock fractures, comprising: a memory, a processor, and a computer program stored in the memory, wherein the processor is configured to implement the steps of the method according to any one of the above embodiments when executing the computer program.

According to another aspect of the present disclosure, there is provided a readable storage medium, wherein the readable storage medium stores a computer program, the computer program comprises program instructions, and when the program instructions are executed by a processor, the steps of the method according to any one of the above embodiments are implemented.

The present disclosure provides a rock fracture initiation prediction method, system, device and storage medium, which have the following beneficial effects:

The present disclosure uses the finite element method to establish a corresponding double fracture model for different fracture types and reservoirs, and analyzes the stress state at the fracture tip and both sides of the fracture by applying confining pressure to the model, thereby predicting whether the fracture is initiating; the method can quickly clarify the fracture initiation law and characteristic, analyze the stress state at the fracture tip and both sides of the fracture, and thus improve the accuracy of fracture initiation prediction.

### BRIEF DESCRIPTION OF THE DRAWINGS

FIG. 1 is a stress state analysis diagram of the grid in the embodiment of the present disclosure;

FIG. 2 is a schematic diagram of the stress field near the fracture tip in the embodiment of the present disclosure;

FIG. 3 is a schematic diagram of the double fracture model in the embodiment of the present disclosure;

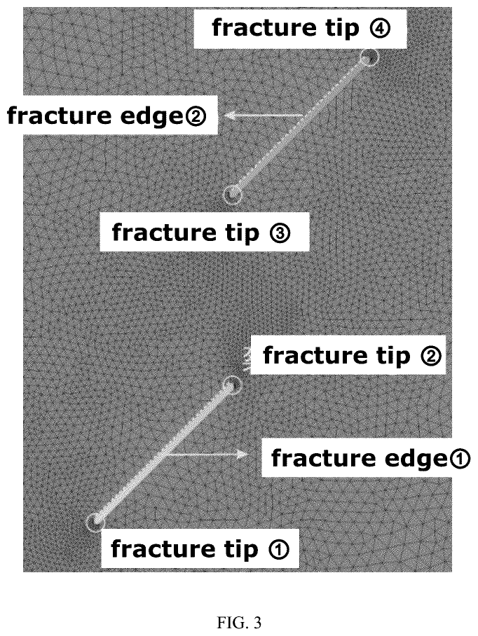

FIG. 4 is a schematic diagram of the maximum principal stress analysis of the four fracture tips under different stress conditions in the embodiment of the present disclosure;

FIG. 5 is a schematic diagram of the maximum principal stress analysis of the four fracture edges under different stress conditions in the embodiment of the present disclosure;

FIG. 6 is a schematic diagram of the maximum shear stress analysis of the four fracture tips under different stress conditions in the embodiment of the present disclosure;

FIG. 7 is a schematic diagram of the maximum shear stress analysis of the four fracture edges under different stress conditions in the embodiment of the present disclosure;

FIG. 8 is a schematic diagram of the maximum shear stress factor under the confining pressure of 30-30 MPa in the embodiment of the present disclosure;

FIG. 9 is a schematic diagram of the maximum shear stress factor under the confining pressure of 35-30 MPa in the embodiment of the present disclosure;

FIG. 10 is a schematic diagram of the maximum shear stress factor under the confining pressure of 40-30 MPa in the embodiment of the present disclosure;

FIG. 11 is a schematic diagram of the maximum shear stress factor under the confining pressure of 45-30 MPa in the embodiment of the present disclosure;

FIG. 12 is a schematic diagram of the maximum effective stress factor under the confining pressure of 30-30 MPa in the embodiment of the present disclosure;

FIG. 13 is a schematic diagram of the maximum effective stress factor under the confining pressure of 35-30 MPa in the embodiment of the present disclosure;

FIG. 14 is a schematic diagram of the maximum effective stress factor under the confining pressure of 40-30 MPa in the embodiment of the present disclosure;

FIG. 15 is a schematic diagram of the maximum effective stress factor under the confining pressure of 45-30 MPa in the embodiment of the present disclosure.

### DETAILED DESCRIPTION OF EMBODIMENTS

The technical scheme in the embodiment of the present disclosure will be clearly and completely described below in conjunction with the drawings in the embodiment of the present disclosure. Obviously, the described embodiment is only a part of the present disclosure, not all of the present disclosure.

Aiming at the dynamic change characteristics of natural fractures with horizontal stress disturbance and the mutual influence behavior between natural fractures with stress disturbance, at the same depth, the present disclosure provides a rock fracture initiation prediction method, which specifically includes the following steps:

According to the actual situation of the reservoir, a double fracture model is established; rock fracture data in the reservoir is obtained; comprehensive consideration is given to the fracture (crack) length, width, fracture density, fracture distribution orientation and other characteristics in the reservoir, and they are used as references for establishing the fracture model. Using the modeling module of the finite element software ANSYS, a slab model is established. The two implanted fractures are parallel to each other and distributed at a 45° angle. The fracture length and fracture width are 0.5 m and 0.02 m respectively, and the perpendicular distance between the two fracture tips is 0.5 m. By meshing the model and further refining the grid around the fracture peripheries and fracture tips, a double fracture model is finally established.

By simulating different horizontal stress differences, the stress changes in the effective range of natural fractures are observed, and the dynamic change process is output; confining pressures of different formations (stratas) are applied to the boundary of the double fracture model to change the stress difference of the horizontal confining pressure and obtain different horizontal stress differences.

The dynamic changes of shear stress, tensile stress and compressive stress at the fracture tip and fracture surface are monitored and recorded; according to different horizontal stress differences, the stress changes of the maximum principal stress on both sides of the fracture and the maximum shear stress at the fracture tip with the horizontal stress difference are analyzed, and the stress states at the fracture tip and both sides of the fracture are obtained respectively.

By analyzing the stress states at the fracture tip and both sides of the fracture, it is predicted whether the fracture will crack and the type of cracking. When the highest value of the maximum shear stress at the fracture tip and both sides of the fracture is greater than the shear modulus of the reservoir or the highest value of the maximum principal stress is greater than the compressive strength of the reservoir, the fracture will crack (the initiation of the fracture will occur).

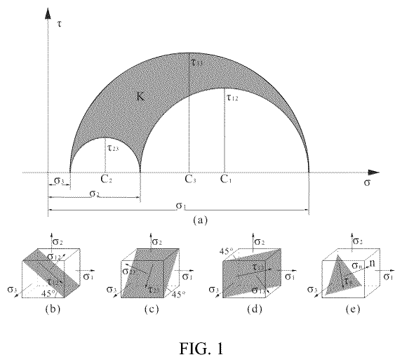

(1) A double-fracture numerical model is established, and the model is divided into grids using gridding technology. Especially, near the fracture tip, the grid is refined, so that the calculation results are more accurate. The stress state analysis of each grid is shown in FIG. 1. The stress state analysis of the grid includes the stress state analysis of the three-dimensional Mohr circle and the four units; FIG. 1 (a) shows a schematic diagram of the three-dimensional Mohr circle, and circles C1, C2, and C3 represent the stress states of three special units b, c, and d respectively; FIG. 1 (b) is unit b, and its corresponding σ and τ distribution ranges are σ₂≤σσ₁ and 0≤τ≤(σ₁−σ₂)/2, respectively; FIG. 1 (c) is unit c, and its corresponding σ and τ distribution ranges are σ₃≤σ≤σ₂ and 0≤τ≤(σ₂−σ₃)/2, respectively; FIG. 1 (d) is unit d, and its corresponding σ and t distribution ranges are σ₃≤σ≤σ₁ and 0≤τ≤(σ₁−σ₃)/2, respectively; FIG. 1 (e) is unit e, which represents a general ground stress state, and the oblique section in FIG. 1 is not parallel to any principal plane.

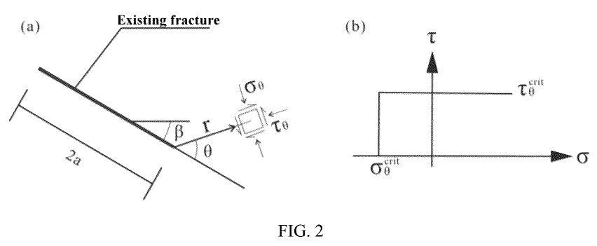

The maximum principal stress (σₘₐₓ) and the maximum shear stress (Tmax) are analyzed in the present disclosure, and the fracture initiation criterion based on stress and strain proposed by Bobet is applied, and then the theory is further developed by Silva and Einstein to analyze the fracture initiation. As shown in FIG. 2, the stress field near the fracture tip is shown, (a) shows a radius stress of one unit pointing to the fracture tip, and (b) is a schematic diagram of Bobet's stress-based criterion.

This initiation criterion is for the initiation and expansion of tension/tensile cracks, showing that the crack will initiate at a certain angle θ, where the tangential stress σ_{θ} (FIG. 2) needs to reach the maximum principal stress (σ_{θmax}) at the tip of the existing crack:

$$\frac{\partial {σ}_{θ}}{\partial θ} = 0 \frac{{\partial }^{2} {σ}_{θ}}{\partial {θ}^{2}} > 0 \qquad ( 1 )$$

When σ_{θmax}=σ_{θ}^{crit}, σ_{θ}^{crit} is the critical tangential stress.

For the initiation and expansion of shear cracks, the shear crack will grow along the θ direction, where the shear stress τ_{θ} (FIG. 2) needs to reach the maximum shear stress (τθₘₐₓ) at the tip of the existing crack:

$$\frac{\partial {τ}_{θ}}{\partial θ} = 0 \frac{{\partial }^{2} {τ}_{θ}}{\partial {θ}^{2}} < 0 \qquad ( 2 )$$

If τθₘₐₓ=τ_{θ}^{crit}, τ_{θ}^{crit} is the critical shear stress.

However, in numerical simulations, the maximum principal stress should be further divided into principal tensile stress and compressive stress, expressed as positive and negative values, respectively. Tensile fractures will initiate at the location with the maximum tensile stress, while compression fractures will initiate at the location with the maximum compressive stress (it should be noted here that due to the principle of “tensile positive and compressive negative” in ANSYS workbench, the compressive stress is negative, so the absolute value of the minimum compressive stress is the maximum value). Whether the fracture initiates or not is related to the mechanical strength of the rock, as well as the magnitude of the tensile stress, compressive stress and shear stress (Silva and Einstein, 2013; Silva and Einstein, 2014), which indicates that if the tensile stress exceeds the tensile strength that the rock can withstand, the tensile fracture will initiate first. Similarly, if the compressive stress exceeds the compressive strength that the rock can withstand, the compressive fracture will initiate first, which is similar to the initiation principle of shear fracture.

(2) Confining pressure is applied to the model boundary to simulate the real stress state of the formation; in addition, in order to simulate the stress state of different formations, the stress difference of the horizontal confining pressure is kept changing and gradually increased.

(3) After post-processing calculations by finite element software, the stress state at the fracture tip and both sides of the fracture is obtained.

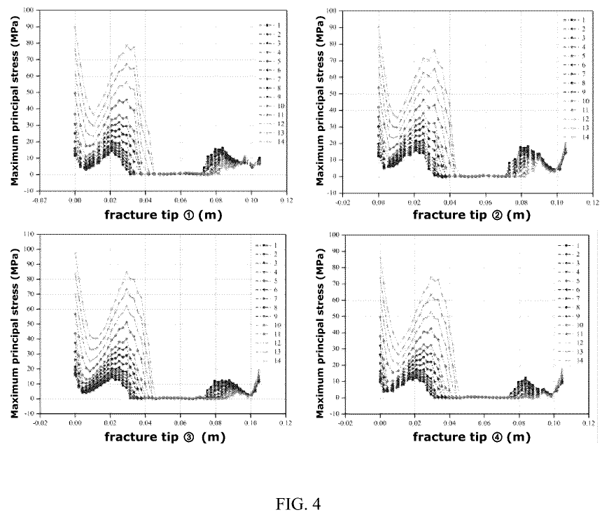

(4) Statistics of stress data at the four fracture tips show that as shown in FIG. 4, \textcircled{1} the maximum principal stress increases with the increase of horizontally-loaded stress difference; \textcircled{2} the fracture tip is obviously larger on the side close to the fracture surface, while the value in the middle of the fracture end is very small, and the fracture is easy to crack on both sides of the fracture end to form a compressive fracture; \textcircled{3} the stress fields between the fractures affect each other, resulting in changes in the stress value at the fracture tips.

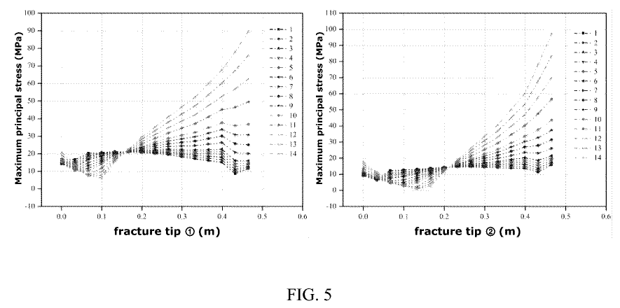

(5) Analysis of the maximum principal stress at the fracture edge shows that as shown in FIG. 5, when the horizontal principal stress difference is small, the maximum principal stress at the fracture edge is evenly distributed; and as the horizontal stress difference increases, the maximum principal stress on the same fracture edge will be unevenly stressed, and under the action of stress and strain, the fracture surface will bend or even break; two stress distribution states will appear on the fracture surface: \textcircled{1} As the horizontal stress difference increases, the maximum principal stress decreases; \textcircled{2} As the horizontal stress difference increases, the maximum principal stress increases accordingly. This is one of the bases for determining the high tortuosity of the fracture.

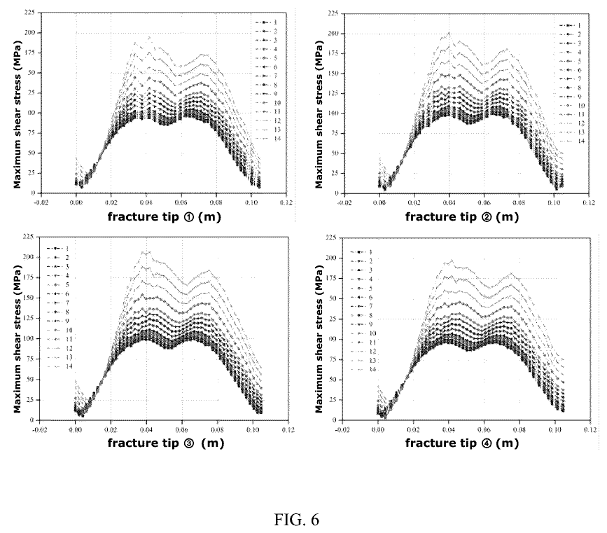

(6) The analysis of the maximum shear stress at the fracture tip shows that, as shown in FIG. 6, \textcircled{1} the maximum shear stress increases with the increase of the horizontally-loaded stress difference; \textcircled{2} the value of the fracture tip in the middle of the fracture end is very high, and the fracture is easy to start in the middle of the fracture end to form a shear crack; \textcircled{3} the stress fields between the adjacent fracture tips can affect each other, resulting in changes in the stress value at the fracture tips.

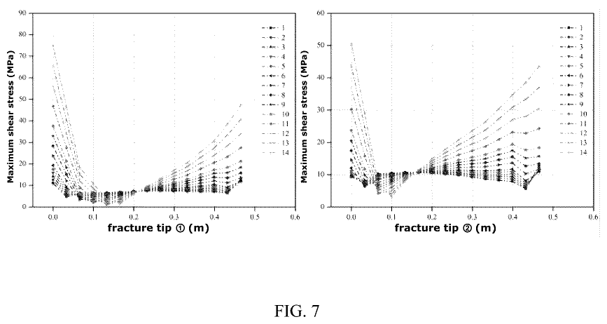

(7) The analysis of the maximum shear stress at the fracture edge shows that, as shown in FIG. 7, \textcircled{1} the maximum shear stress is larger at both ends of the fracture edge and smaller in the middle, which is manifested as shear stress concentration at both ends of the fracture; \textcircled{2} the maximum shear stress value along the fracture edge increases with the increase of the horizontal stress difference; \textcircled{3} similar to the maximum principal stress distribution characteristics, a stress intersection point appears at the fracture edge. Under any horizontal stress difference conditions, the maximum principal stress and maximum shear stress at this point remain unchanged.

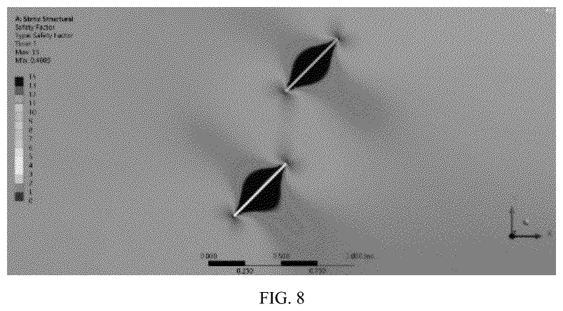

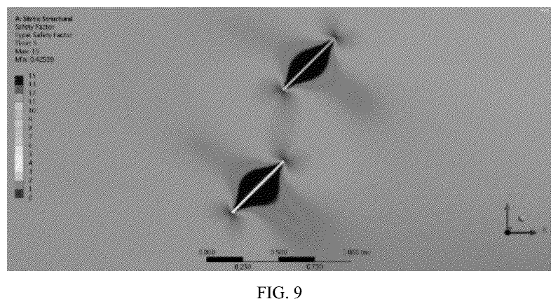

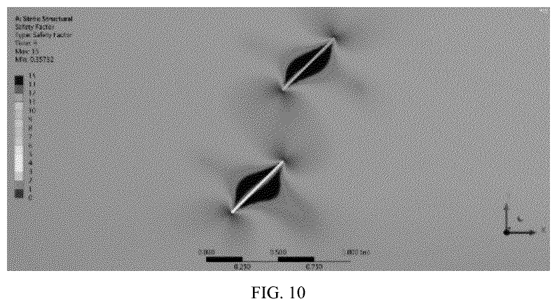

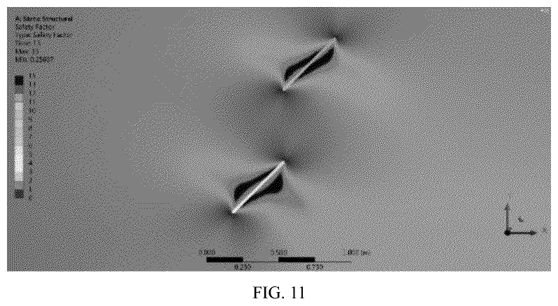

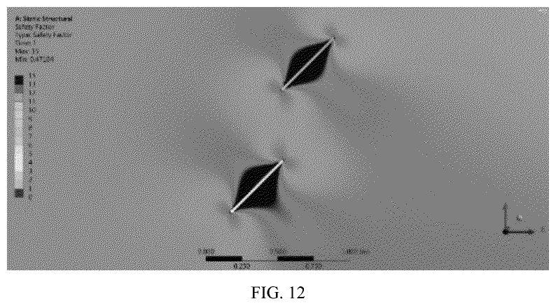

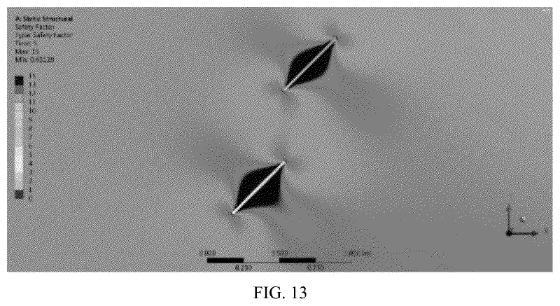

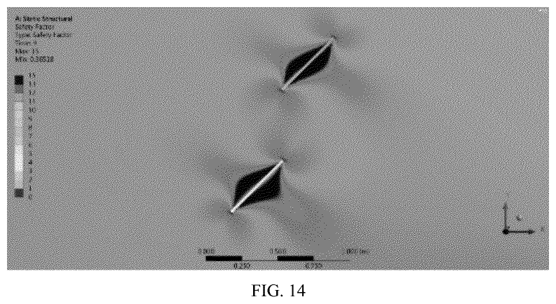

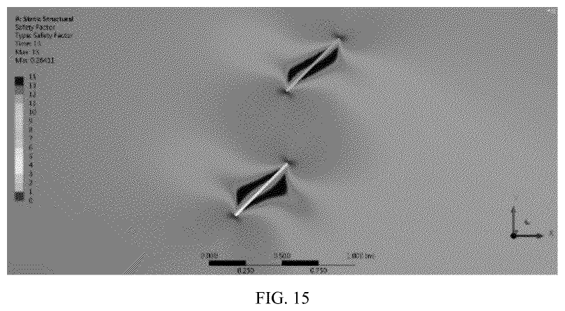

(8) The corresponding maximum shear stress factors of various stress stage are shown in FIGS. 8, 9, 10, and 11, and the plane change cloud diagrams of the maximum effective stress factor are shown in FIGS. 12, 13, 14, and 15, which are used to judge the dynamic change of the fracture periphery corresponding to the stress loading change.

By analyzing the magnitude of the maximum shear stress and the maximum principal stress at the fracture tip and the fracture edge (FIG. 4, FIG. 5, FIG. 6, FIG. 7), when the maximum shear stress at the fracture tip and the fracture edge is the highest value and is greater than the shear modulus of the reservoir, the point is the priority initiation point, forming a shear crack; similarly, when the maximum principal stress is the highest value and is greater than the compressive strength of the reservoir, the point is the priority initiation point, forming a compressive crack (the judgment mechanism of tensile cracks is similar).

Based on the same inventive concept, the present disclosure proposes a rock fracture initiation prediction system, including:
an acquisition module for acquiring rock fracture data in a reservoir of a working area;
a model establishing module for establishing a double fracture model based on the fracture data by adopting a finite element software ANSYS;
a confining pressure application module for applying confining pressures of different strata to a boundary of the double fracture model to change stress differences of horizontal confining pressures and obtain different horizontal stress differences;
an analysis module for analyzing the corresponding stress changes of the maximum principal stresses and the maximum shear stresses at both sides of a fracture and a fracture tip as the horizontal stress differences change, and obtaining a stress state at the fracture tip and both sides of the fracture, according to the different horizontal stress differences;
a prediction module for predicting whether the fracture is initiating by the stress state at the fracture tip and both sides of the fracture, wherein when the highest value of the maximum shear stresses at the fracture tip and both sides of the fracture is greater than a shear modulus of the reservoir, or the highest value of the maximum principal stresses at the fracture tip and both sides of the fracture is greater than a compressive strength of the reservoir, the fracture is judged to be initiating.

Based on the same inventive concept, the present disclosure also proposes a computer device for predicting initiation of rock fractures, comprising: a memory, a processor, and a computer program stored in the memory, wherein the processor is configured to implement the steps of the rock fracture initiation prediction method when executing the computer program.

Based on the same inventive concept, the present disclosure also proposes a readable storage medium, wherein the readable storage medium stores a computer program, the computer program comprises program instructions, and when the program instructions are executed by a processor, the steps of the rock fracture initiation prediction method are implemented.

The above is only a preferred specific embodiment of the present disclosure, but the protection scope of the present disclosure is not limited thereto. Any technician familiar with the technical field within the technical scope disclosed by the present disclosure, according to the technical solution and its inventive concept of the present disclosure, can make equivalent replacement or change to the technical solutions of the present disclosure, such replacement or change should be covered within the protection scope of the present disclosure.

What is claimed is:

1. A method for predicting initiation of rock fractures, comprising the following steps:
obtaining rock fracture data in a reservoir of a working area;
adopting a finite element software ANSYS to establish a double fracture model based on the fracture data;
applying confining pressures of different strata to a boundary of the double fracture model to change stress differences of horizontal confining pressures and obtain different horizontal stress differences;
according to the different horizontal stress differences, analyzing the corresponding stress changes of maximum principal stresses and maximum shear stresses on both sides of a fracture and a fracture tip as the horizontal stress differences change, and obtaining a stress state at the fracture tip and both sides of the fracture;
predicting whether the fracture is initiating by the stress state at the fracture tip and both sides of the fracture, wherein when the highest value of the maximum shear stresses at the fracture tip and both sides of the fracture is greater than a shear modulus of the reservoir, or the highest value of the maximum principal stresses at the fracture tip and both sides of the fracture is greater than a compressive strength of the reservoir, it is judged that the fracture is initiating,
wherein the step of “according to the different horizontal stress differences, analyzing the corresponding stress changes of maximum principal stresses and maximum shear stresses on both sides of a fracture and a fracture tip as the horizontal stress differences change, and obtaining a stress state at the fracture tip and both sides of the fracture” specifically comprises:
when the horizontal stress difference is close to 0 MPa, the maximum principal stress on both sides of the fracture is evenly distributed; and as the horizontal stress difference increases, the maximum principal stress on the same fracture edge is unevenly stressed, and the fracture surface bends or breaks under the action of stress and strain; wherein two stress distribution states occur on the fracture surface: as the horizontal stress difference increases, the maximum principal stress decreases; or as the horizontal stress difference increases, the maximum principal stress increases accordingly;
as the horizontal stress difference increases, the maximum shear stress increases, and the fracture initiates in the middle of the fracture tip to form a shear fracture,
wherein the stress changes of the maximum principal stresses on both sides of the fracture and the maximum shear stress at the fracture tip with the change of the horizontal stress differences are analyzed by establishing a plane change cloud map of the maximum principal stresses on both sides of the fracture and the maximum shear stress at the fracture tip with the change of the horizontal stress differences according to different horizontal stress differences.

2. The method according to claim 1, wherein the establishment of the double fracture model specifically comprises the following steps:
acquiring lengths, widths, densities and distribution orientations of the fractures in the reservoir;
using the finite element software ANSYS to establish a slab model, and implanting two fractures in the slab model, wherein the two fractures are parallel to each other and are distributed at a 45° inclination, the length and width of the two fractures are 0.5 m and 0.02 m respectively, and a perpendicular distance between two fracture tips is 0.5 m;
by meshing the slab model and fracture peripheries and fracture tips, establishing the double fracture model.

3. The method according to claim 1, wherein the maximum principal stress comprises tensile stress and compressive stress, wherein when the fracture initiation occurs at a position with the maximum tensile stress, a tensile fracture is formed; when the fracture initiation occurs at a position with the maximum compressive stress, a compressive fracture is formed; when the tensile stress exceeds a tensile strength that the rock fracture itself can withstand, the tensile fracture is first cracked; when the compressive stress exceeds a compressive strength that the rock itself can withstand, the compressive fracture is first cracked.

4. A system for predicting initiation of rock fractures, comprising:
an acquisition module for acquiring rock fracture data in a reservoir of a working area;
a model establishing module for establishing a double fracture model based on the fracture data by adopting a finite element software ANSYS;
a confining pressure application module for applying confining pressures of different strata to a boundary of the double fracture model to change stress differences of horizontal confining pressures and obtain different horizontal stress differences;
an analysis module for analyzing the corresponding stress changes of the maximum principal stresses and the maximum shear stresses at both sides of a fracture and a fracture tip as the horizontal stress differences change, and obtaining a stress state at the fracture tip and both sides of the fracture, according to the different horizontal stress differences;
a prediction module for predicting whether the fracture is initiating by the stress state at the fracture tip and both sides of the fracture, wherein when the highest value of the maximum shear stresses at the fracture tip and both sides of the fracture is greater than a shear modulus of the reservoir, or the highest value of the maximum principal stresses at the fracture tip and both sides of the fracture is greater than a compressive strength of the reservoir, the fracture is judged to be initiating.

5. A computer device for predicting initiation of rock fractures, comprising: a memory, a processor, and a computer program stored in the memory, wherein the processor is configured to implement the steps of the method according to claim 1 when executing the computer program.

6. A readable storage medium, wherein the readable storage medium stores a computer program, the computer program comprises program instructions, and when the program instructions are executed by a processor, the steps of the method according to claim 1 are implemented.
